(19) United States
(12) Patent Application Publication
(10) Pub. No.: US 2018/0330433 A1
(43) Pub. Date: Nov. 15, 2018

(54) ATTRIBUTING MEANINGS TO DATA CONCEPTS USED IN PRODUCING OUTPUTS

(71) Applicant: Connect Financial LLC, Wellesley, MA (US)

(72) Inventors: Martin Frenzel, Wayland, MA (US); Michael George Keirnan, Belmont, MA (US); Charles F. Baker, IV, Brookline, MA (US); Jonathan Connor Morgan, Brighton, MA (US); Allen Charles Madsen, Boston, MA (US); Madison Elizabeth Packer, Somerville, MA (US); Jessica Michelle Abrahams, Cambridge, MA (US)

(73) Assignee: Connect Financial LLC, Wellesley, MA (US)

(21) Appl. No.: 15/593,870

(22) Filed: May 12, 2017

(51) Int. Cl. G06Q 40/02

(52) U.S. Cl. CPC G06Q 40/02

(57) ABSTRACT

Among other things, improvements are made in the operation of a computer that processes input data values and generates internal data values that depend on the input data values and on mappings defining the processing. Input data values are received from input data sources. The input data values conform to input data concepts. The input data values are processed to map them according to specified mappings to internal data values that conform to internal data concepts. At least one of the mappings is (a) from input data values that conform respectively to two or more different input data concepts or (b) to internal data values that conform respectively to two or more different internal data concepts, or (c) both. Updated information is applied about characteristics of at least one of the mappings that will affect the internal data values that are the result of the processing, the information being updated as late as the beginning of the processing of the input data values.

### BACKGROUND

This description relates to attributing meanings to data concepts used in producing outputs.

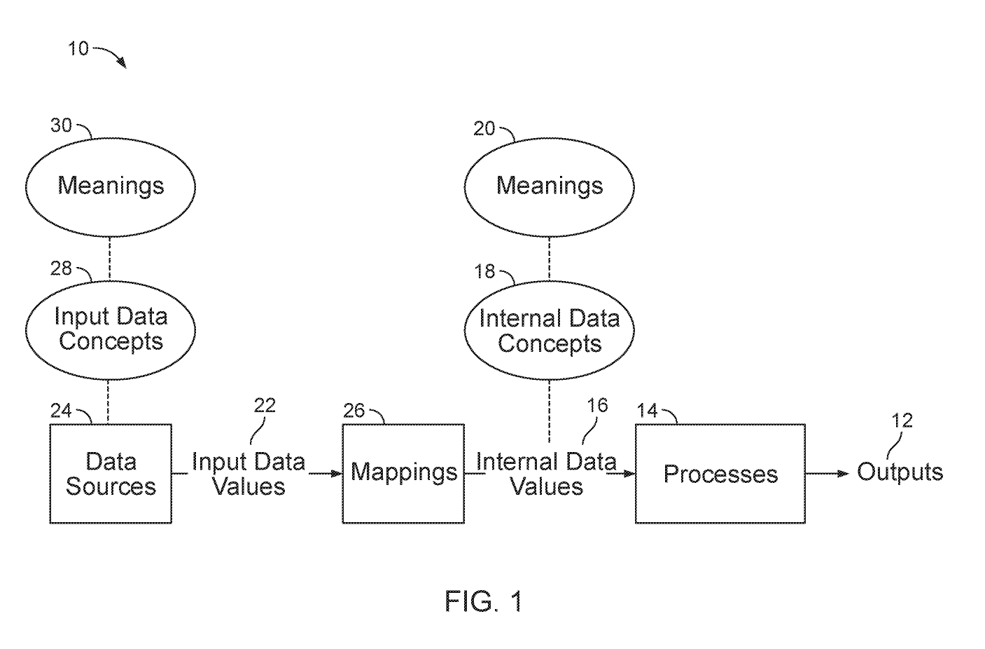

As shown in FIG. 1, typical data processing systems 10 produce outputs 12 by applying specified processes 14 to internal data values 16 that represent internal data concepts 18 having particular meanings 20. At least some of the internal data values can be derived from input data values 22 provided by one or more data sources 24 using mappings 26 that address the fact that input data values available from the sources represent input data concepts 28 that have meanings 30 that may not directly match the meanings of the internal data concepts intended by the developer of the system. The mappings are predefined when the system is built—based on the characteristics of the data sources and the data values that they provide—and remain unchanged to assure that, for example, numerical outputs generated by the system conform to the intentions of the designer of the system.

For example, a system may be designed to use an internal data concept of “annual percentage rate (APR) of interest on a credit card debt.” The system may use that internal data concept in a computational process that generates an output representing an “annualized cost of the interest based on the current balance” by multiplying internal data values for an “APR” internal data concept by internal data values for an “outstanding-balance” internal data concept. For this purpose, the system needs to determine the internal data values based on input data values.

In this example, suppose that there are two sources (source A and source B) of input data values related to the APR internal data concept and that neither of the sources may be expected always to provide input data values that square exactly with the developer's intended meaning of the APR internal data concept. Based on characteristics of sources A and B and the data values that they provide, the developer may decide to attribute to the APR internal data concept the meaning “the higher of the APRs provided by source A and source B.” The designer in typical known systems would then specify a corresponding, unchanging mapping from the data values provided by sources A and B to the data values for APR to be used by the system in producing the output.

Input data values related to an internal data concept can be obtained from sources external to the system, such as a data vendor, or internal to the system, such as a company's own databases of enterprise resource planning information, financial information, or customer relationship management information, among others.

### SUMMARY

In general, in an aspect, operation is improved of a computer that processes input data values and generates internal data values that depend on the input data values and on mappings defining the processing. Input data values are received from input data sources. The input data values conform to input data concepts. The input data values are processed to map them according to specified mappings to internal data values that conform to internal data concepts. At least one of the mappings is (a) from input data values that conform respectively to two or more different input data concepts or (b) to internal data values that conform respectively to two or more different internal data concepts, or (c) both. Updated information is applied about characteristics of at least one of the mappings that will affect the internal data values that are the result of the processing, the information being updated as late as the beginning of the processing of the input data values.

Implementations may include one or a combination of two or more of the following features. The internal data values are processed to produce an output for an end user. The input data values include an input data value provided by the end user. The input data concepts conform to an input ontology. The internal data concepts conform to an internal ontology. The internal data concepts conform to an internal ontology and at least one of the mappings is based on the input ontology and the internal ontology. The input data values are processed according to versions of the mappings for which the characteristics of the mapping are current as of the processing of the input data values. The characteristics of the mappings include one or a combination of two or more of: characteristics of an ontology to which the input data concepts belong, characteristics of relationships between internal data concepts, characteristics of the input data concepts, characteristics of the internal data concepts, or characteristics of the input data sources. The input data sources have characteristics that affect the meaning, significance, or usefulness of the input data values. The characteristics of the input data sources include one or a combination of two or more of reliability, availability, currency, accuracy, consistency, or precision. The characteristics of the mapping include one or a combination of two or more of: the identities of the input data sources for the mapping, the identities of the internal data sources for the mapping, the number of input data sources, the number of internal data sources, or computational instructions for the mapping. The updated information is stored in a file. The information in the file is expressed according to a predefined language.

In general, in an aspect, operation is improved of a computer that processes input data values and generates internal data values that depend on the input data values and on mappings defining the processing. A computational process is run that generates internal data values that depend on input data values and on mappings defining the computational process, at least one of the mappings being (a) from input data values that conform respectively to two or more different input data concepts or (b) to internal data values that conform respectively to two or more different internal data concepts, or (c) both. An administrative user updates characteristics of the mappings during the running of the computational process. The computational process is caused to generate the internal data values according to the updated characteristics.

Implementations may include one or a combination of two or more of the following features. The internal data values are processed to produce an output for an end user. The input data values include an input data value provided by the end user. The input data concepts conform to an input ontology. The internal data concepts conform to an internal ontology. The internal data concepts conform to an internal ontology and at least one of the mappings is based on the input ontology and the internal ontology. The characteristics of the mappings include one or a combination of two or more of: characteristics of an ontology to which the input data concepts belong, characteristics of relationships between internal data concepts, characteristics of the input data concepts, characteristics of the internal data concepts, or characteristics of the input data sources. The method of claim in which sources of the input data sources have characteristics that affect the meaning, significance, or usefulness of the input data values. The characteristics of the input data sources include one or a combination of two or more of reliability, availability, currency, accuracy, consistency, or precision. The characteristics of the mapping include one or a combination of two or more of: the identities of the input data sources for the mapping, the identities of the internal data sources for the mapping, the number of input data sources, the number of internal data sources, or computational instructions for the mapping. The updated information is stored in a file. The information in the file is expressed according to a predefined language.

In general, in an aspect, a computational process is run that applies mappings of input data values to internal data values and generates outputs for an end user based on the internal data values. The data values conform to one or more ontologies of data concepts. It is automatically determined that an input data value used by a mapping is unavailable during the running of the computational process. The missing value is expressed through and translated from the internal ontology to the input ontology.

Implementations may include one or a combination of two or more of the following features. The automatic obtaining of the unavailable input data value includes presenting an inquiry to the end user and receiving a reply from the end user. The automatic obtaining of the input data value includes using one or more of the ontologies to identify the input data value that is unavailable. The mappings are changeable and the applying the mappings includes applying mappings that are current as of the running of the computational process. The mappings are based on: characteristics of the ontologies, characteristics of internal data values, characteristics of the input data values, or two or more of them.

In general, in an aspect, input data values are received from two or more data sources input data values. The input values correspond to input data concepts. The input data values include numerical input data values. The two data sources have different degrees of one or more of the following characteristics: reliability, availability, currency, accuracy, consistency, or precision. The input data values are mapped to one or more internal data values. Outputs are generated that are used as inputs for a recommender system that will generate guidance for end users based on the input data values and the internal data values. The guidance is not limited to numerical data values.

Among other advantages of these aspects, features, and implementations are the following. The mappings that are applied to input data values and internal data values at run time can be changed at any time up to and including run time and therefore do not need to be formulated only at development time. Therefore, the mappings need not be static, that is, unchanging over time, but can accommodate changes in the input data values, the internal data values, the sources of data values, the way in which administrative and other users view the data values and the corresponding data concepts, the ontologies in which the data concepts are organized, and a variety of other factors. Data concepts, mappings, and ontologies can be defined easily and updated at any time or from time to time in some cases through an interactive graphical user interface or in other ways. Outputs to end users can be in any form and can provide guidance through interaction over a long period of time without concern about issues associated with the input data values or the input data sources.

These and other aspects, features, and implementations can be expressed as methods, apparatus, systems, components, program products, methods of doing business, means or steps for performing a function, and in other ways.

These and other aspects, features, and implementations will become apparent from the following descriptions, including the claims.

### DESCRIPTION

FIGS. 1, 2, 3, 5, and 8 are block diagrams.

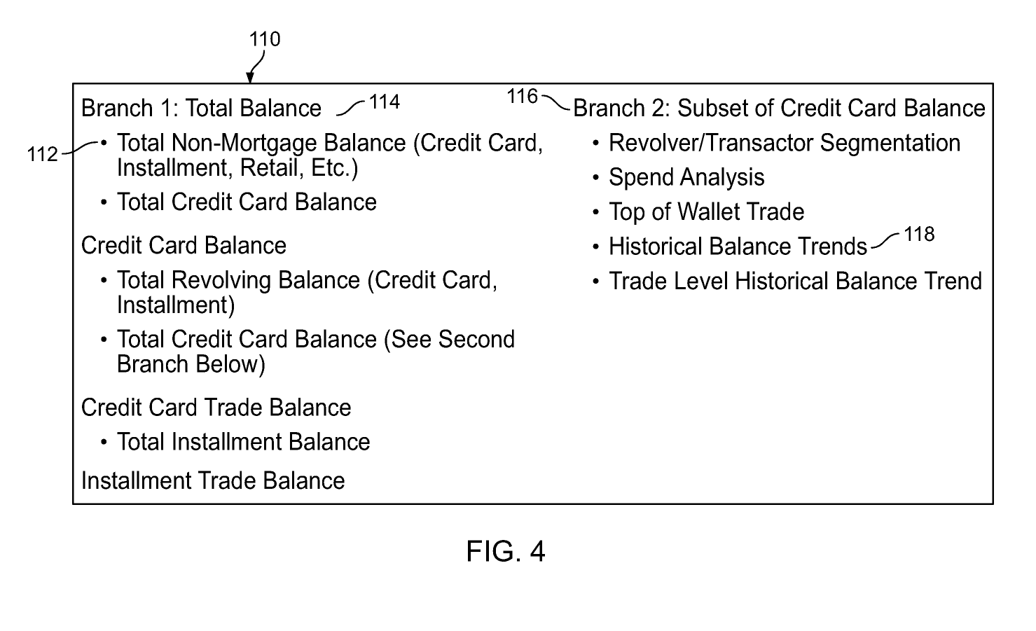

FIG. 4 is a diagram of ontologies.

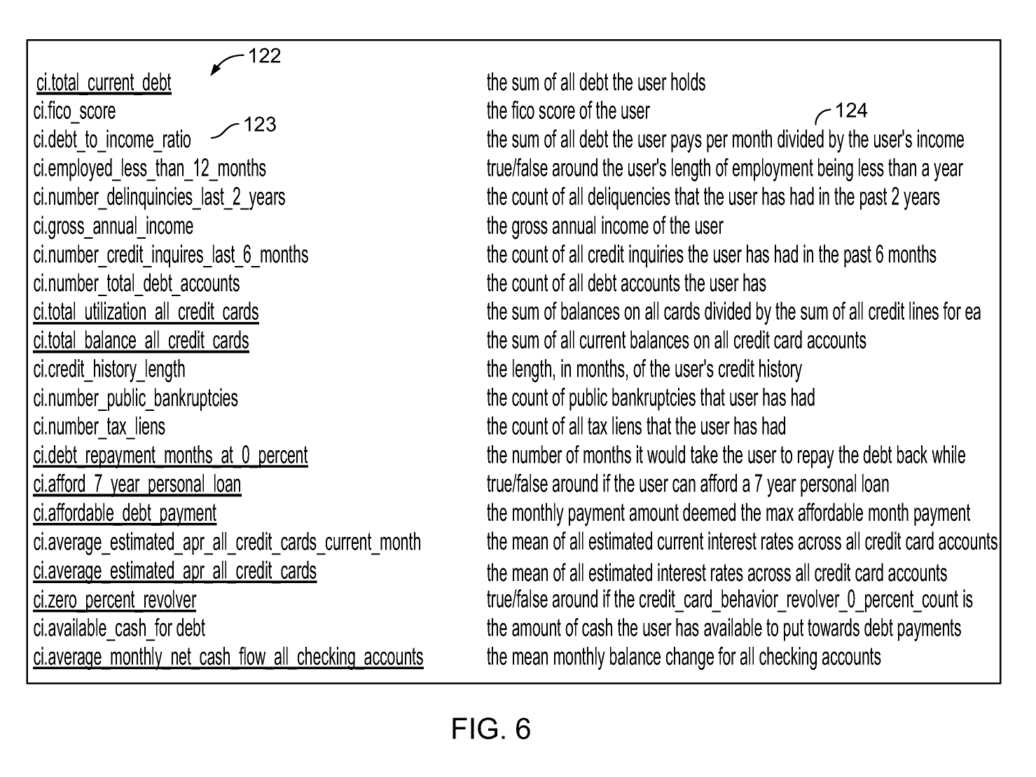

FIG. 6 is a data concept list.

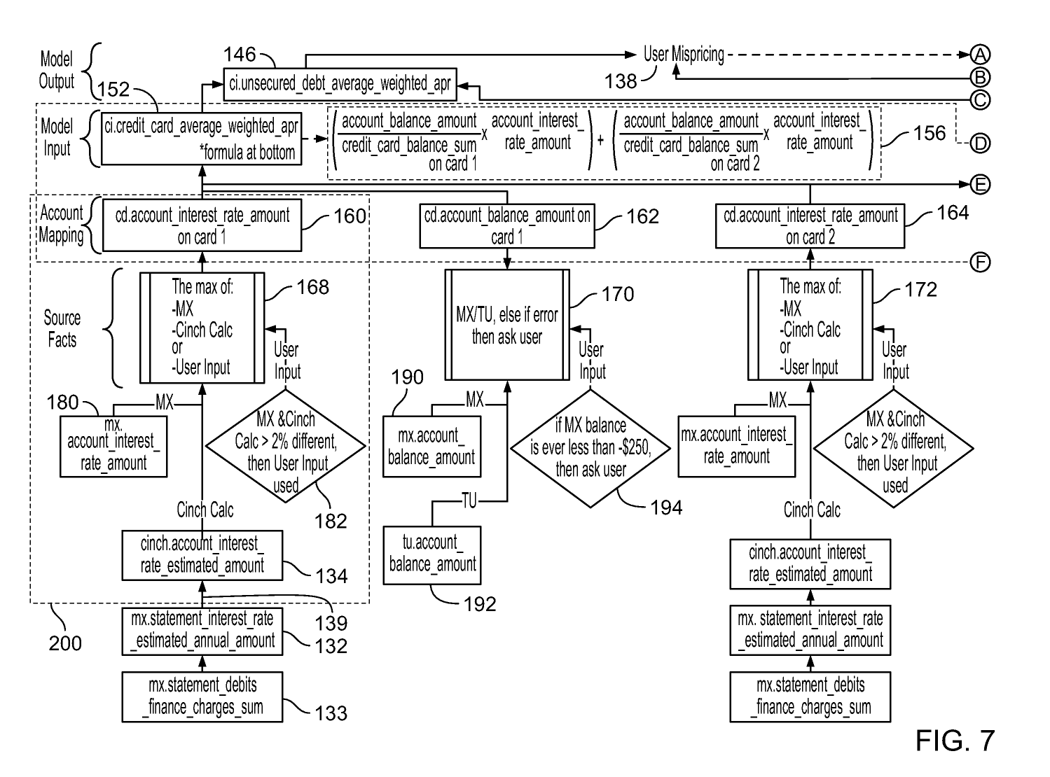

FIG. 7 is a user interface display.

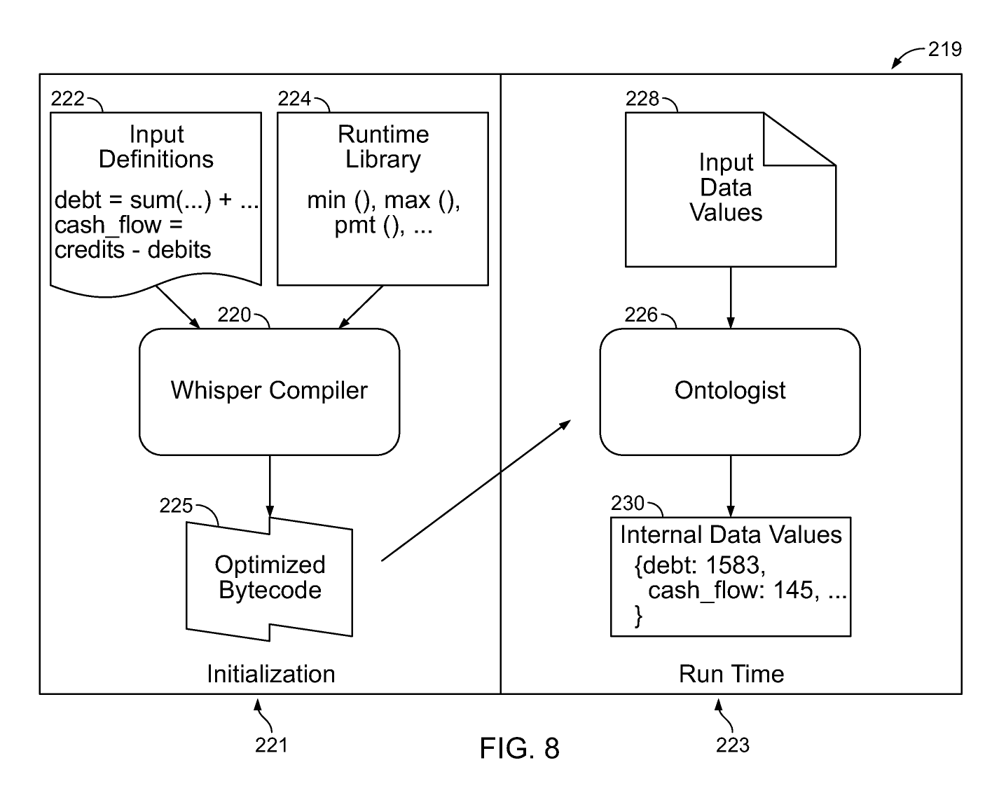

FIG. 9 is a sequence diagram.

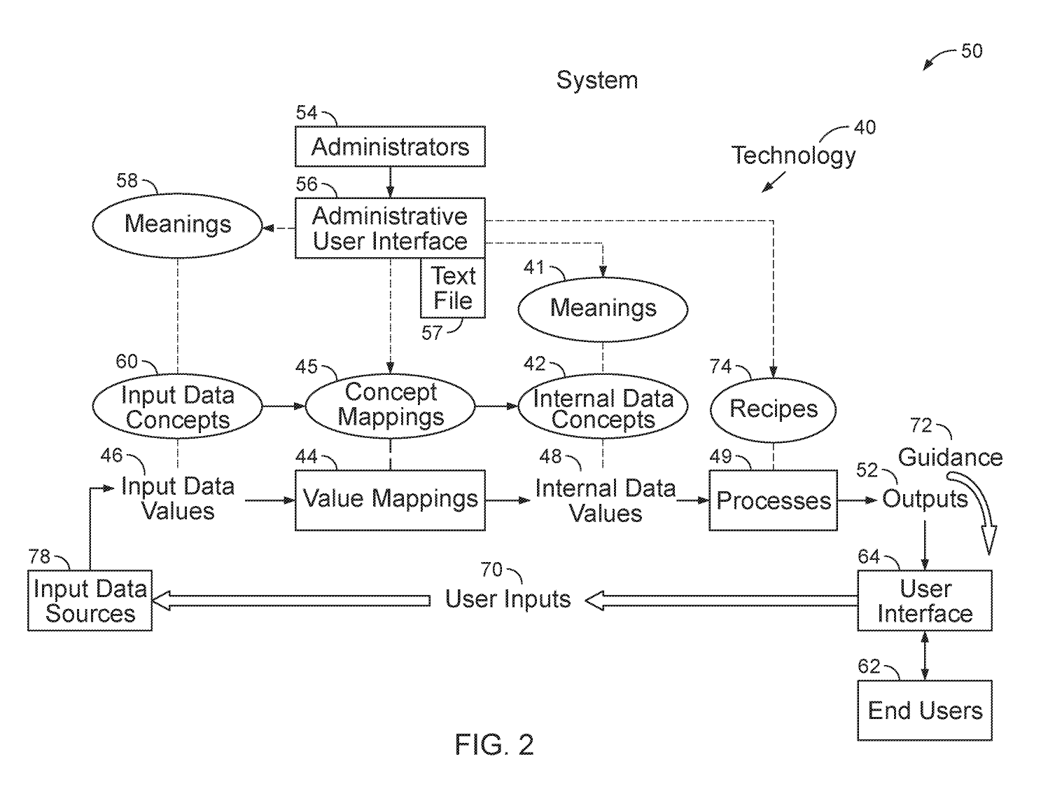

As shown in FIG. 2, here we describe technology 40 that enables meanings 41 that will be attributed to internal data concepts 42 (and the corresponding mappings 44 from input data values 46 to internal data values 48 that correspond to the internal data concepts) to be determined at any time, including after the technology 40 or the system 50 of which it is part has been developed and built and even as late as run-time, when the technology 40 is generating internal data values or the system 50 is generating outputs 52 based on the data input values and internal data values using processes 49.

We sometimes refer to three stages in the operation of the system 50 (and its technology 40) and to three categories of people who participate in those stages: development time, configuration time, and run time. During development time, the system is being designed and built by developers. During configuration time, administrators 54 typically employed by business users of the system can work through an interactive graphical user interface 56 (or in other ways) to configure the technology, for example, by defining computational recipes (discussed later), meanings 58, 41 to be attributed to input data concepts 60 and internal data concepts 42, and concept mappings 45 of meanings among input data concepts and internal data concepts, among other things. Run time is when, typically, end users 62 are interacting with the system 50 through a user interface 64 that is presented by a browser or a mobile app, for example. During runtime, input data values and internal data values are being processed to generate premises and outputs for the end users, among other activities. In general, the three stages may overlap in time and in function, and the same people may be developers and administrators or administrators and end users. For example, configuration time and run time may overlap in that administrators can be altering the definitions, meanings, recipes, and mappings in real time as the end users are interacting with the system. Administrators need not be specially trained in computer or software technologies, but only need be able to deal with and express the meanings of data concepts and how they are to be mapped from and to other data concepts.

We use the term “mapping” broadly to include, for example, any translation, transformation, computation, combination, or other conversion from one or more inputs to one or more outputs, such as a mapping from one or more data concepts to one or more other data concepts. A mapping of concepts (which we sometimes refer to as a concept mapping) can be applied to data values during run time. We sometimes refer to a mapping applied to data values as a value mapping.

We use the term “meaning” broadly to include, for example, any definition, connotation semantic, explanation, understanding, or interpretation, or combinations of them of a subject, such as a data concept or a data value, to name two.

We use the term “internal data concept” broadly to include, for example, any notion, view, thought, or conception about data and that is of use (among other places) internally to the technology 40 or to the system 50.

We use the term “input data concept” broadly to include, for example, any notion, view, thought, or conception about input data and that is of use (among other places) externally to the technology 40 or to the system 50.

We use the term “recipes” broadly to include, for example, any analytical, mathematical, statistical, or logical process, or combination of them that can be applied to one or more inputs to generate one or more outputs. The inputs can include, for example, internal data values or input data values or premises, and the outputs can be premises used within a system or provided as outputs of the system.

In some implementations, the technology 40 receives input data values and produces internal data values using the mappings. One or more of the internal data values that it produces can then be used as inputs by other parts of the system 50, notably the processes 49 that use recipes to produce premises and ultimate outputs 52 to be provided to end users.

The technology 40 (and the overall system 50 of which it is part) is useful in contexts, among many others, in which interactions through the user interface 64 with human users 62 extend over a period of time (e.g., days, months, years, or decades) and are used to advise or otherwise guide the users with respect to an aspect of the user's activities or behavior sometimes with the goal of improving an outcome of the activities or behavior. The system 50 provides guidance that is useful even though the users may at times act irrationally, ignore the guidance, or take a different course than the one suggested. The outputs of the system (the guidance) can be numerical, non-numerical, or a combination of the two, and can be expressed in a variety of ways, such as possibilities, suggestions, hypothetical scenarios, questions, or challenges, among others. The interactions may occur in sequences in which the user provides inputs 70 (which can be treated as part of the input data values 46), the system provides guidance 72 in the form of outputs, the user provides other inputs, and the system provides other guidance, iteratively, without necessarily reaching a defined end point. In some examples, the guidance is intended to be a sequence of directionally correct pieces of advice that change over time as the context is monitored.

In some cases, the outputs 52 are generated by statistical processes or analytical processes or combinations of them that are part of system 50 and are configured by administrators during configuration time or run time. The guidance to the user (represented in the outputs of the system) are based on “recipes” 74 defined by the administrators. The recipes are executed by processes 49 at run time to generate premises based on internal data values 48. The outputs 52 are based on the premises. Additional information describing examples of features of system 50 are included in U.S. patent application Ser. No. 14/304,633, filed Jun. 13, 2014; Ser. No. 14/989,935, Jan. 7, 2016, and Ser. No. 15/231,266, filed Aug. 8, 2016, which are incorporated here by reference.

The technology 40 and the overall system 50 are especially useful in contexts that have one or more of the following characteristics:
a. A given data source 78 and the input data values that it provides have characteristics that affect the meaning, significance, and usefulness of the values, including one or more of: reliability, availability, currency, accuracy, consistency, and precision, among others.
b. The behavior of a user related to the guidance provided by the system may be unpredictable, unreliable, or unresponsive.
c. The guidance to the user is intended to be effective over time periods during which the context, data sources, meanings of data concepts, behavior of users, or desired outcomes, or combinations of them, among other things, will change.

Although we describe examples of the technology 40 and system 50 related to financial contexts and particularly examples that involve providing guidance to end users who are consumers with respect to activities and behavior related to their financial situations, the technology 40 and the system 50 are applicable to a very wide variety of contexts including realms other than financial, and financial examples other than those related to consumer guidance.

One or more of the recipes 74, which are executed in the processes 49, use internal data values 48 to generate premises that are the basis of the outputs 52. For the recipes to work properly, the internal data concepts that are the basis of the internal data values used by the recipes must conform to the defined meanings 41, and the administrators and the technology must be able to rely on the defined meanings; otherwise the system will operate in a garbage in/garbage out mode. Therefore, when the administrator specifies an internal data concept, say, “APR of a credit card,” as an input data concept of a recipe, she must be confident that the corresponding internal data values will conform to the defined meaning of “APR of a credit card”, a meaning that she is aware of and understands. This meaning of “APR of a credit card” could be “A credible estimate of the annualized interest expense of carrying a balance on a specified credit card.”

On the other hand, although the input data sources 78 may base the input data values 46 that they provide on their own defined input data concepts 60 (or ones that can be inferred by or interpreted by an administrator of the technology 40), none of those input data concepts may match the internal meaning “APR of a credit card” as “A credible estimate of the annualized interest expense of carrying a balance on a specified credit card.” For example, one input data source may provide input data values that are accurate but not current. Another input data source may provide data values that are current but not accurate. A third input data source may provide credible current values but not provide them reliably; they may be sometimes available and sometimes not. In other words, in a variety of examples, the source meaning of an input data concept may not match the internal meaning for that data concept. Even so, a developer who is familiar with the characteristics of the sources and the meanings of their data concepts may be able to define a mapping 74 from the input data concepts of the data values provided by one or more sources for a given data concept to the internal data concept enabling the intended meaning of the internal data concept to be met. Then at run time, for example, the system can receive input data values for the input data concepts from those sources, transform them based on the mappings to internal data values for the internal data concept, and provide them to the premise generators.

As an example, internal data values for the “APR of a credit card” might be obtained by a mapping that instructed the technology to accept the values of source A without modification if source A, known to be unreliable in its availability, is actually making values available; otherwise to combine the values of source B weighted 75% with the values of source C weighted 25%.

Significantly, the mapping is applied at run time, and the mapping can be altered freely by the administrators at configuration time or run time or both. Alterations may be prompted by changes in the characteristics of the input data sources, the input data concepts and meanings, the intentions and interpretations of the administrator, and for a wide variety of other reasons and combinations of them.

Therefore, the effect of applying a mapping is determined at the time when internal data values of the internal data concept are needed by, for example, the processes 49 based on recipes 74 or mappings 44 and may change at any time up to the moment when the mapping is applied. For example, at a first time, T1, a mapping to “APR of a credit card” may specify that data sources B and C be weighted 75% to 25%. At time T2, and administrator may determine that a more credible value will be generated by changing the mapping so that the weightings are 50% and 50%. The administrator may make the change easily by interacting with controls of the user interface 56 or in other ways (for example altering a text file). After time T2 whenever “APR of a credit card” is needed the new weightings will be applied. As a result, the manner in which input data concepts are used for formulating a corresponding internal data concept can change over time and therefore the meaning of “APR of a credit card” can change over time. That meaning is not fixed at development time nor is it fixed at configuration time.

Although we have so far discussed input data concepts and internal data concepts and their related meanings individually, data sources typically organize categories of their data according to ontologies or the existence of such ontologies is explicit or can be inferred. The internal data concepts and related meanings of the technology 40 also can be organized according to one or more internal ontologies. By understanding, defining, and taking advantage of ontologies of input data concepts and internal data concepts, administrators can more easily develop mappings from categories of input data concepts to categories of internal data concepts. Ontologies can be expressed in a variety of ways including database schemas, the Resource Description Framework (RDF) of the World Wide Web Consortium (W3C), and others.

We use the term “ontology” broadly to include, for example, any organizational framework for meanings or concepts, such as a hierarchy, a tree, a classification, a ranking, a scale, an ordering, an outline, an arrangement, or combinations of them, to name a few.

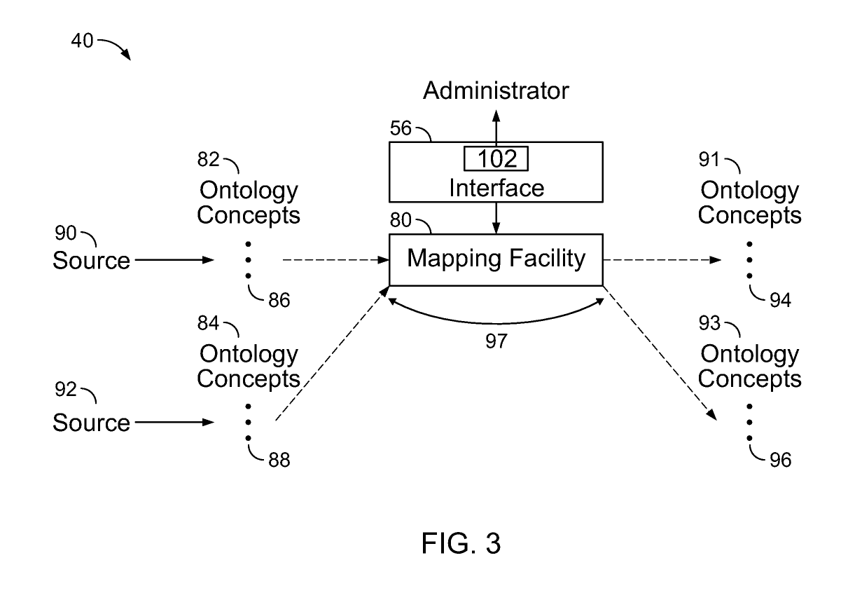

As shown in FIG. 3, the technology 40 provides a mapping facility 80 that can be made available to administrators through an interactive user interface 56 (or in some cases by editing of a text file) that enables mediation between existing ontologies 82, 84 of input data concepts 86, 88 of input data sources 90, 92 and internal ontologies 91, 93 of internal data concepts 94, 96. In defining the mappings, the administrators are able to express and change complex relationships 97 that map any M input data concepts to any N internal data concepts. The complex relationships can be created and updated at any time up to and including during run time even while end user outputs are being generated. The technology 40 could include a comprehensive graphical user interface 102 to enable administrators to observe, understand, manipulate, alter, organize, and define data concepts, ontologies, mappings, and relationships among them. In some implementations, the information about the mappings can be stored, observed, understood, manipulated, altered, organized, and defined in a simple text file and manipulated by a user through a text editor.

As shown in FIG. 4, for example, an ontology 110 of a data input source may include a hierarchy of input data concepts 112 headed by the input data concept “total balance” 114. That concept has (e.g., is the sum of) two main component data concepts: “total non-mortgage balance” and “total credit card balance”. “Total credit card balance” in turn has (e.g., is the sum of) three components: “credit card balance,” “credit card trade balance,” and “installment trade balance.” And so on. At the same time, in this example, suppose that the technology 40 includes an internal data concept “subset of credit card balance” 116 that has five internal data concepts 118 under it. The administrator can use the mapping facility to define mappings from one or more of the (M) input data concepts to one or more of the (N) internal data concepts.

An example of a complete version of an ontology of internal data concepts follows:
Total Debt Balance
   Total Secured Debt Balance
   Total Unsecured Debt Balance
1 Total Unsecured Debt Balance
   Total Personal Loan Debt Balance
   Total Credit Card Debt Balance
2 Total Credit Card Debt Balance (sum of trades below)
   Credit Card account status revolving=True (for 1 or more trades, see 2nd branch)
   Credit Card account balance (for 1 or more trades)
3 Credit Card account balance
   Credit Card balance MX
   Credit Card balance TU
   Credit Card balance user

The mappings can refer not only to input data concepts and internal data concepts as objects but also to subjects and relationships. For example, a mapping can express a relationship between input data concepts and an internal data concept as a formula to be applied to the input data concepts to obtain the internal data concept. In some cases the subject of the mapping can be the relationship and the internal data concept produced by the mapping can be the formula itself.

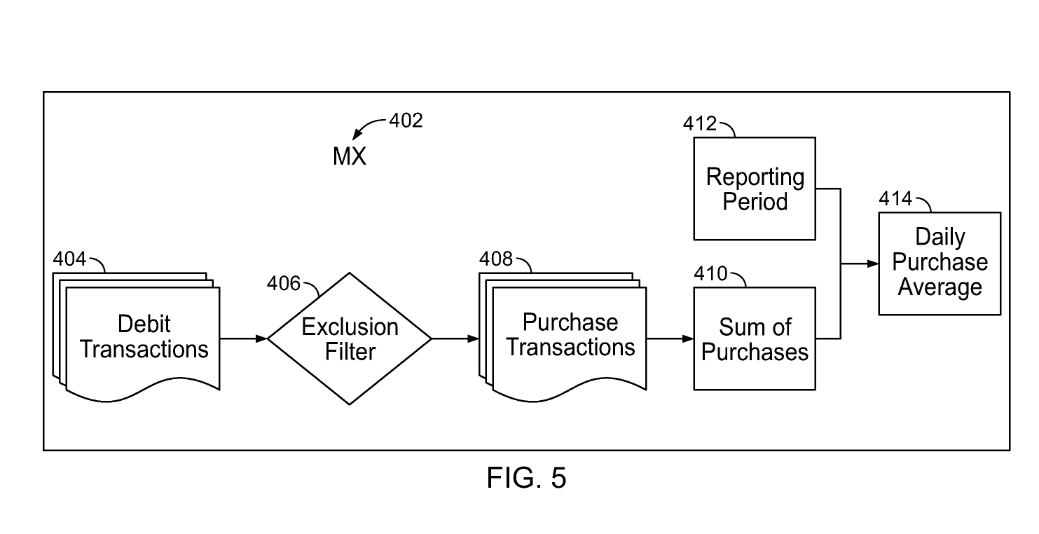

FIG. 5 illustrates an example of a mapping from input data values of a data source to an internal data value. A data source 402 makes available debit transactions 404 of a card holder. By applying an exclusion filter, the transactions that involve purchases 408 can be derived. The purchase values of those transactions can be summed 410 and divided by a period 412 represented by the transactions to generate a daily purchase average 414 for that period. Items 410, 412, 414 represent internal data values associated with internal data concepts while items 404, 406, and 408 represent input data values associated with input data source concepts.

As shown in FIG. 6, technology 40 can use a list 122 of unique internal data concepts 123 and descriptions 124 of each of them. For example, the uniquely named internal data concept ci.debt_to_income_ratio 123 is described as having the meaning “the sum of all debt the user pays per month divided by the user's income” 124.

FIG. 7 illustrates how mappings and recipes can be used to produce internal datat concepts from input data concepts and to produce premises and outputs from internal data concepts. FIG. 7 also illustrates how mappings and recipes can vary their use of input data concepts depending on a time frame under consideration; in other words, the recipes can operate dynamically (non-statically). The boxes and lines of FIG. 7 represent input data concepts, internal data concepts, mappings, processes that use the internal data concepts and input data concepts to produce premises and outputs, and the flow of information among these elements.

Many of the blocks in the bottom half of FIG. 7 represent input data concepts, for example, input data concepts such as 132 that begin with the characters “mx” represent input data concepts of input data values provide by an input data source MX. The remainder of the identifier of each concept specifies a unique input data concept for that input data source, in accordance with an input ontology. For example, block 132 refers to an estimated annual amount for the statement interest rate. Block 134 begins with the word “cinch” (which refers to a system developed by Cinch Financial, Boston, Mass.) and represents an account interest rate estimated amount.

In the example of FIG. 7, a premise 138 (User Mispricing) is to be generated by the processes 49 of the system 50 when the expression shown in block 140 is true. That expression recites a mathematical relationship to be tested using two internal data concepts 142, 144. (These internal data concepts are part of the internal ontology of the technology 40 and are generated by the technology for use by the processes 49 of the system 50.) The internal data concept 142 is generated by a mapping that combines an internal data concept 146 and internal data concepts 148, 150, the values for which are generated by fair price models. (Additional information about how the fair price models may be implemented is described in U.S. patent application Ser. No. 14/989,935 mentioned earlier.) Internal data concept 146 in turn is generated by a mapping from internal data concepts 152 and 154. A mapping 156 generates the internal data concept 152, for example, from internal data concepts 160, 162, 164, 166. The pairs of internal data concepts 160, 162 and 164, 166 are produced by similar mappings 168, 170, and 172, 174 applied to input data values for two different credit cards as shown.

The mapping 168 uses an input data concept 180 from the MX source, an internal input data concept 134 derived (by a simple mapping 139) from input data concepts 132 and 133, and a tested input from a user 182.

The internal data concept 162 is fed back from the mapping 156 as a way to check the appropriateness of one of the internal data values used in the mapping. A mapping 170 tests those values against input data values from two sources 190, 192. If an error results from applying the mapping, then the user is asked for the correct input data value 194.

At run time, an engine in the technology 40 will continuously execute the mappings on the input data values according to the current versions of the mappings that result from the work of the administrator and will provide the mapped internal data values to the processes that execute other mappings to produce other internal data values. The generated data values shown in FIG. 7 then can be used as inputs to processes 49 (FIG. 2) which generate premises and outputs for the end user.

In some implementations, as illustrated in FIG. 7, there can be two styles of mappings: simple and dynamic. A simple mapping is a direct static translation from an input data concept to an internal data concept of the kind illustrated as mapping 139 from block 132 to block 134 in FIG. 7.

An example of a dynamic mapping is illustrated by the set of blocks 200 in FIG. 7. There the mapping includes a mapping block 168. The internal data values generated by the mapping for the internal data concept of block 160 are not static but are only determinable at run time based in part on the comparisons of data values and on the input of the user.

FIG. 7 also illustrates a second dynamic mapping example 202 that involves applying a given mapping more than once to different sets of data values (for example associated with two different credit cards of a given end user) and then aggregating the data values.

Therefore, mappings can be both dynamic (in the sense that a specific current version of a mapping can produce different values at run time depending on the circumstances) and configurable (in the sense that the current version of a mapping can be changed by the administrator at any time up to and including run time) or both.

In some implementations, the mappings, ontologies, and data concepts are expressed and updated by the administrators in a source text file 57 (FIG. 2) through the administrative user interface 56 (which in some cases can be a simple text editor), in forms of expression that are conveniently understood by humans.

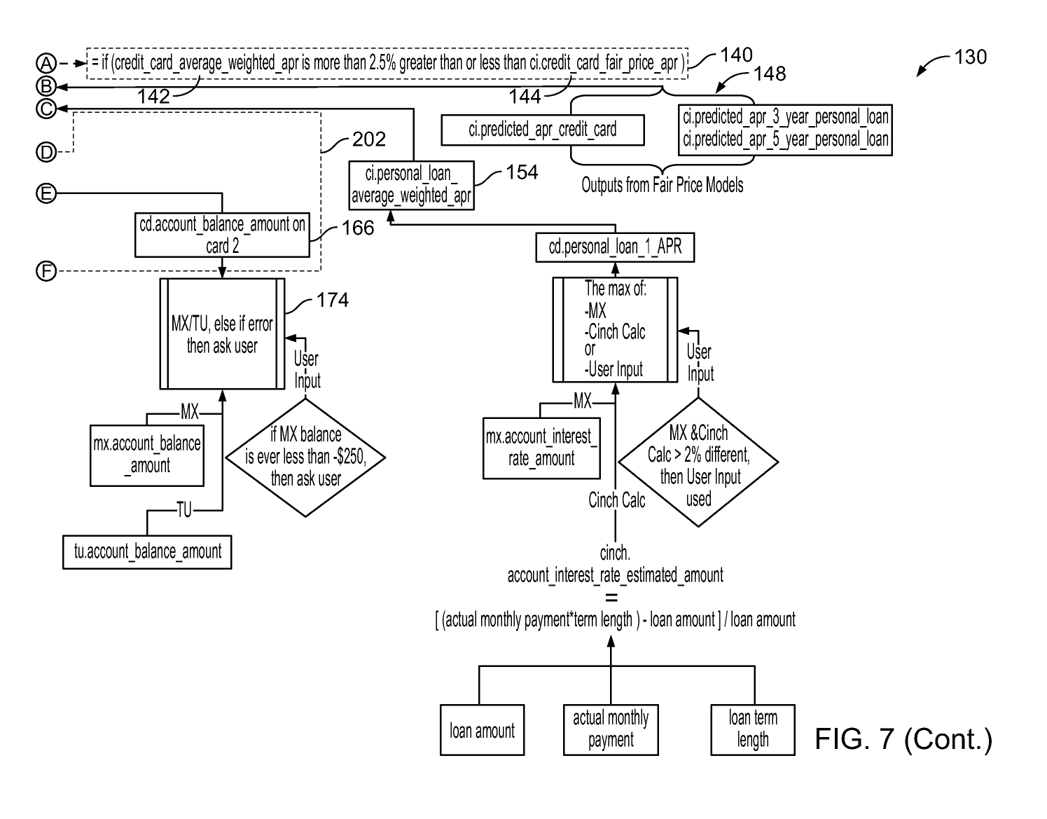

As shown in FIG. 8, operation of the runtime engine 219 that is part of the technology 40 includes an initialization phase 221 and a run time phase 223. The initialization phase prepares the engine for run time and is executed when the technology is started up and when any of the input data concepts or mappings is updated by an administrator during runtime of the system 50. During the initialization phase, a compiler 220 uses the data concept, recipe, and mapping definitions 222 contained in the source text file and runtime libraries 224 to generate optimized executable bytecode 225 that is executed at run time by an ontology process 226 (the engine of the technology 40). Process 226 runs the bytecode in effect to apply the definitions 222 to the input data values 228 to map them to internal data values 230 which can be used by the premise generators to produce premises and outputs for delivery to the end users. Compilation of the source file is fast, and the compiled bytecode enables fast execution. During the run time phase, multiple instances of the runtime engine run in parallel serving end user requests and enabling end user guidance. By effecting rolling re-initializations of the instances, the technology can adjust to changes made by administrators to the mappings, definitions, and ontologies, essentially in real time with respect to the activities of the end users, and therefore continue to provide guidance to the end user without interruption.

For purposes of expressing the input data concepts, the internal data concepts, their meanings, the mappings, and the ontologies, the technology uses an expression language. An example of a definition of a data concept is the following.

Name: user.total_current_debt
Description: the sum of all debt the user holds
Formula: user_profile_debt_amount

Each data concept as expressed in the text file includes:

Name: a unique name of the data concept. The first character of the name must be alphabetic or an underscore [A-Za-z_]. Each remaining character can be an alphanumeric or an underscore [a-zA-Z0-9_]. Compound names in which the portions of the name are separated by period characters, for example user.total_current_debt, imply a hierarchy (ontology) in which the periods delimit branches that can be used for grouping related data concepts.

Type: an optional code used to impart additional meaning to the data concept. Type is similar to a data type, but is less strict in that the value and interpretation of Type is up to the application and is not enforced in the language itself. Type is optional. If supplied, it must come between Name and Description. Type can be used by user interfaces to inform the presentation of the data concept. For example, the type usd indicates a data concept that is in US dollars and can be formatted accordingly.

Description: a textual description of the data concept, which can be multiple lines. Along with the Name, the Description supplies meaning to (defines) the data concept.

Formula: an arithmetic definition of the data concept. Can reference input data concepts as well as internal data concepts.

Data concepts can be scalar quantities like the integer 42 or the string “good”. Data concepts can also be lists of scalars like [1, 2, 4], objects such as:

{
”name”: ”main checking account”,
”balance”: 500.00
}

or lists of objects.

In the example above the formula is a simple reference to an input concept, but formulas can be arithmetic expressions as well. Some examples:

Name: y
Formula: x + 1
Name: z
Formula: (y * 2) + 1

At runtime the above formulas require a value of x to be input in order to compute y and z. If a value of 10 is supplied for x, then y will be computed to be 11 and z will be computed to be 23.

Below are other examples of internal data concepts including formulas used to determine them from other data concepts. These examples would be stored in the text file and could be text edited in that file to add, remove, and update the entries.

# Arithmetic expression in function call
Name: user.allocatable_lump_cash
Type: usd
Description: allocatable one-time cash
Formula : max (user.total_cash − user .working_capital
* 1.5, 0
# Count of a list
Name: user.credit_ca rd .all.count
Type : int
Description : number of total credit cards a user has
Formula: count (credit_card .accounts[ ])
# Summing property of a list of objects
Name : user.credit_card .all.minimum_payme nts
Type : usd
Estimated: true
Description : sum of minimum payments on all credit cards
Formula: sum(credit_card .accounts [ ].mx
.payment_minimum_estimated_amount
# Nested function calls
Name: category.top_ranked_name
Type: st ring
Description :
Formula : if(category .consumption .rank= 1, 11 consumption11 ,
if(category .savings .rank = 1, “savings”,
if(category.debt.rank = 1, “debt”,
if(category .protection.rank = 1, “protection”, “unknown”))))

Following is a more complicated example.

# Complicated formula example showing the use of a function from an
extension
# library ML.loan_approvel_modell( ) which takes many arguments
Name: user.personal_loan .likely_preapproved
Type: Boolean
Description: likely to be pre-approved for a personal loan
Formula: (ML.loan_approval_model1(user.credit_ca rd .revolving
.ending_balance,

user.credit_score, user.unsecu
red_debt_obligation_to_income_ratio,
user.employed_less_than_a_year) > 0.5)

and (ML .loan_approval_model2(user.credit_ca rd .revolving
.ending_balance,
36,

user.gross_annual_income,
user.employed_less_than_a_year, user.public_delinquencies,
user.public_derogatory_ma rks, user.credit_inquiries,
user.debt_accounts,
user.credit_card.all.utilization, user.public_bankruptcies,
user.tax_liens,
user.credit_history) > 0)

and (ML .loan_approval_model2(user.credit_card
.revolving.ending_balance,
60,

user.gross_annual_income,
user.employed_less_than_a_year, user.public_delinquencies,
user.public_derogatory_ma rks, user.credit_inquiries,
user.debt_accounts,
user.credit_card .all.utilization, user.public_bankruptcies,
user.tax_liens,
user.credit_history) > 0)

A standard function library is included in the engine of the technology. Functions provided by the library can include:

Name: credit_card_payment
Formula: max(minimum_payment, suggested_payment)

The above sets the credit_card_payment model input to the larger of the minimum_payment and the suggested_payment. The following standard library functions are available:

abs (x) - absolute value of x
ceil (x) - smallest integer >= x
count (list) - number
exp (x) - Euler's number e raised to the power of x
filter (name, list, op, value) - find the elements of list whose property
name matches the condition specified by op and value.

For example: filter(“balance”, user.checking_accounts, “gt”, 1000) returns a list of checking accounts that have a balance greater than 1000.

floor (x) - largest integer <= x
if(test, trueValue, falseValue) - Return trueValue if test is true

else return falseValue

log (x) - natural logarithm (base e) of x
max (x, y, ...) - largest value in arguments (accepts list or any
number of arguments)
mean (x, y, ...) - arithmetic mean of arguments (accepts list or any
number of arguments)
nper (r, pmt, pv) -# of payments of periodic payments of a given
amount required to payoff a debt
pmt (r, nper, pv) - periodic payment amount required to payoff a
debt in a given time
min (x, y, ...) - smallest value in arguments (accepts list or any
number of arguments)
sum(x, y, ...) - sum of arguments (accepts list or any number of
arguments)

Functions can be used anywhere values can be used, so they can nest.

In addition to the standard library, additional function libraries are easy to add to the runtime engine. The ontology process includes a machine learning library that predicts loan approval and APR based on model inputs.

The engine is also used to define business rules, that is, recipes for output guidance (advice) to end users. A business rule is a condition and a result that applies if the condition is true. A set of ordered rules form a decision tree: the result of applying the ruleset is the result of the first rule whose condition is true.

Here is a sample simplified ruleset:

rule
if debt < $10
advise: no_financing_needed reason:
you_are_good
rule
if fico > 650
advise: personal_loan reason:
lowest_rate_for_you

The above ruleset produces the no_financing_needed advice when debt is <$10. Otherwise if fico is >650 the ruleset produces the personal_loan advice. Otherwise there is no output produced.

A ruleset can also produce values for named internal data concepts instead of or in addition to advice:

rule
if debt < $10
{
estimated_one_time_cash: 500
estimated_recurring_cash: 200
estimated_impact: 10
}

where the key/value pairs in curly braces are output values.

The defined mappings, input data concepts, internal data concepts, recipes, and ontologies of the source file can be changed at any time up to and during run time, through the user interface, after which the source file is recompiled.

As shown in FIG. 9, in an example sequence of operation of the technology 40 and the overall system 50, an end user application 300 (accessible, for example, through a web browser or a mobile app) enables the end user to sign up and link her financial accounts 302 to the technology 40. Input sources of data values 304 are then able to provide input data values 306 (which we sometimes call “source facts”) to a database 307 for staging. The ontology process 308 applies mappings 311 to the input data values 310 identified in accordance with the input ontology to generate internal data values 312 identified in accordance with the internal ontologies for which there are available input data values necessary to apply to the mappings. Premises generators 314 (here called a hunch service) use the generated internal data values to generate premises and pass them with internal data values 316 to a strategy process 318 (which is sometimes referred to as a model). The strategy process generates outputs 319 for delivery to recommenders 321 which will provide guidance to the end user. In some implementations, the premise generators 314 (hunch service) and the strategy service 318 operate by running rules of the kind illustrated in the very simple version of the ruleset shown above, and returning the resulting outputs. The strategy process performs at least the following functions 320: a. determines a strategy for the end user based on the generated premises; to do so, it applies the stored mappings to the generated internal data values; b. uses a minimal set of input data values to do a.; and c. when information necessary for generating the output is missing, seeks the missing information.

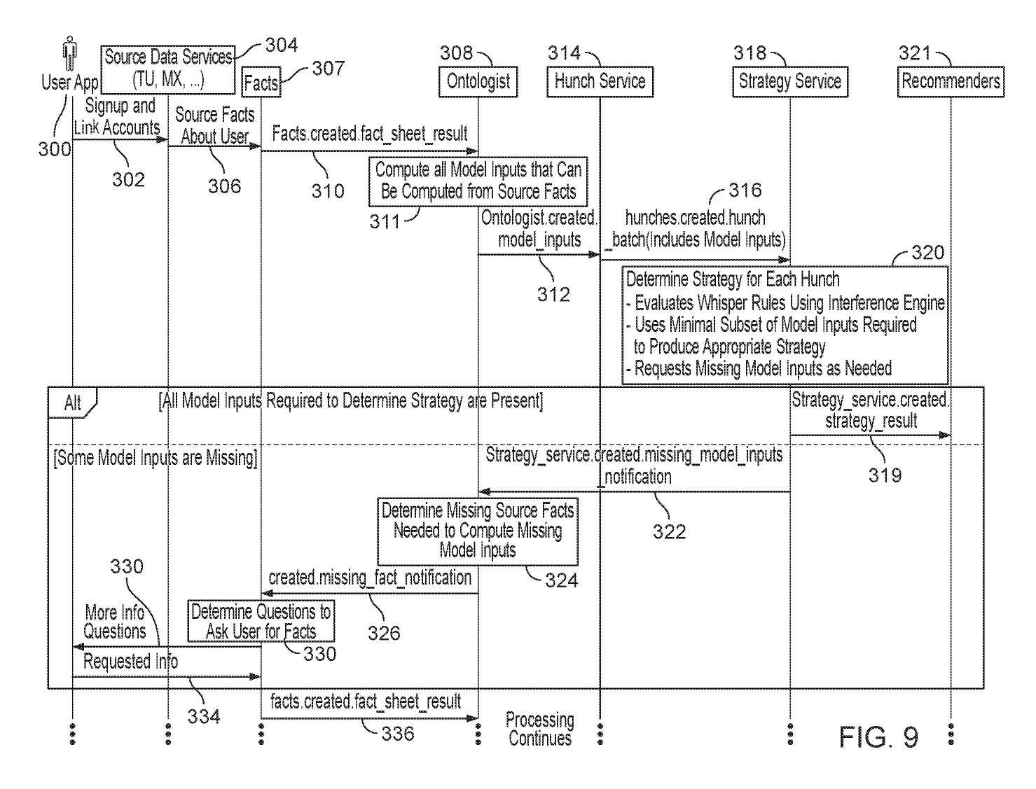

Referring to the bottom portion of FIG. 10, if not all input data values needed for generating the strategies are present, the strategy process returns a notification 322 to the ontology process. The ontology process determines 324 missing input data values that will be needed to complete the mappings to the needed internal data values that are missing. Then the ontology process sends a notification 326 to the database 307, which determines 330 what questions to ask the end user in order to obtain the missing input data values. The questions 332 are sent to the end user through the end user interface. The requested information is returned 334; is converted to an expression of the missing input data values 336 which is returned to the ontology process and the remaining sequence is followed as discussed earlier. In some cases, other methods could be used to generate the missing data values.

Other implementations are also with the scope of the following claims.

1. A technological method for improving a technological process by which a computer coordinates and times a use of stored internal data values conforming to internal data concepts to produce results for presentation to end-users, the method comprising
receiving input data values from input data sources, the input data values conforming to input data concepts,
by computer computationally processing the input data values according to specified mappings from input data concepts to internal data concepts, to produce internal data values that conform to the internal data concepts and storing the internal data values,
the computational processing of the input data values according to the specified mappings from the input data concepts to the internal data concepts, to produce the internal data values that conform to the internal data concepts, comprising (a) processing input data values that conform respectively to two or more different input data concepts or (b) producing internal data values that conform respectively to two or more different internal data concepts, or (c) both,
by computer computationally deriving results to be presented to an end-user based at least in part on the stored internal data values,
presenting the computationally derived results to the end-user through a user interface,
receiving from an administrative user, updated information about characteristics of at least one of the mappings that will affect the internal data values that are the result of the computational processing and will affect the computationally derived results to be presented to the end-user, the updated information being applied as late as the beginning of the computational processing of the input data values, and
adjusting, based on the received updated information, the computationally derived results to be presented to the end-user essentially in real time and without interruption with respect to activities of the end-user in the user interface.

2. The method of claim 1 in which the results comprise guidance.

3. The method of claim 2 in which the input data values include an input data value provided by the end user.

4. The method of claim 1 in which the input data concepts conform to an input ontology.

5. The method of claim 1 in which the internal data concepts conform to an internal ontology.

6. The method of claim 4 in which the internal data concepts conform to an internal ontology and at least one of the mappings is based on the input ontology and the internal ontology.

7. The method of claim 1 comprising processing the input data values according to versions of the mappings for which the characteristics of the mapping are current as of the processing of the input data values.

8. The method of claim 1 in which the characteristics of the mappings comprise one or a combination of two or more of: characteristics of an ontology to which the input data concepts belong, characteristics of relationships between internal data concepts, characteristics of the input data concepts, characteristics of the internal data concepts, or characteristics of the input data sources.

9. The method of claim 1 in which the input data sources have characteristics that affect the meaning, significance, or usefulness of the input data values.

10. The method of claim 9 in which the characteristics of the input data sources include one or a combination of two or more of reliability, availability, currency, accuracy, consistency, or precision.

11. The method of claim 1 in which the characteristics of the mapping comprise one or a combination of two or more of: the identities of the input data sources for the mapping, the identities of the internal data sources for the mapping, the number of input data sources, the number of internal data sources, or computational instructions for the mapping.

12. The method of claim 1 in which the updated information is stored in a file.

13. The method of claim 12 in which the information in the file is expressed according to a predefined language.

14. A method for improving operation of a computer that processes input data values and generates internal data values that depend on the input data values and on mappings defining the processing, comprising
running a computational process that generates internal data values that depend on input data values and on mappings defining the computational process,
at least one of the mappings being (a) from input data values that conform respectively to two or more different input data concepts or (b) to internal data values that conform respectively to two or more different internal data concepts, or (c) both,
enabling an administrative user to update characteristics of the mappings during the running of the computational process, and
causing the computational process to generate the internal data values according to the updated characteristics in real time as end-users are interacting with a user interface in which results are being provided based on the internal data values.

15. The method of claim 14 comprising
processing the internal data values to produce an output for an end user.

16. The method of claim 15 in which the input data values include an input data value provided by the end user.

17. The method of claim 14 in which the input data concepts conform to an input ontology.

18. The method of claim 14 in which the internal data concepts conform to an internal ontology and at least one of the mappings is based on the input ontology and the internal ontology.

19. The method of claim 14 in which the characteristics of the mappings comprise one or a combination of two or more of: characteristics of an ontology to which the input data concepts belong, characteristics of relationships between internal data concepts, characteristics of the input data concepts, characteristics of the internal data concepts, or characteristics of the input data sources.

20. The method of claim 14 in which sources of the input data sources have characteristics that affect the meaning, significance, or usefulness of the input data values.

21. The method of claim 20 in which the characteristics of the input data sources include one or a combination of two or more of reliability, availability, currency, accuracy, consistency, or precision.

22. The method of claim 14 in which the characteristics of the mapping comprise one or a combination of two or more of: the identities of the input data sources for the mapping, the identities of the internal data sources for the mapping, the number of input data sources, the number of internal data sources, or computational instructions for the mapping.

23. The method of claim 14 in which the updated information is stored in a file.

24. The method of claim 23 in which the information in the file is expressed according to a predefined language.

25. A method comprising
running a computational process that applies mappings of input data values to internal data values and generates outputs for an end user based on the internal data values, the input data values conforming to one or more ontologies of input data concepts and the internal data values conforming to one or more ontologies of internal data concepts,
automatically determining that an input data value used by a mapping from the input data value to an internal data value is unavailable during the running of the computational process and expressing the missing value through and translating it from the internal ontology to the input ontology.

26. The method of claim 25 in which the automatic obtaining of the unavailable input data value comprises presenting an inquiry to the end user and receiving a reply from the end user.

27. The method of claim 25 in which the automatic obtaining of the input data value comprises using one or more of the ontologies to identify the input data value that is unavailable.

28. The method of claim 25 in which the mappings are changeable and the applying the mappings comprises applying mappings that are current as of the running of the computational process.

29. The method of claim 25 in which the mappings are based on: characteristics of the ontologies, characteristics of internal data values, characteristics of the input data values, or two or more of them.

30. A method comprising
receiving from two or more data sources input data values corresponding to input data concepts, the input data values comprising numerical input data values, the two data sources having different degrees of one or more of the following characteristics: reliability, availability, currency, accuracy, consistency, or precision,
mapping the input data values to one or more internal data values, and
generating outputs that are used as inputs for a recommender system that will generate guidance for end users based on the input data values and the internal data values, the guidance not being limited to numerical data values.

31. The method of claim 1 in which the adjusting is done at runtime.
